(19) United States
(12) Patent Application Publication
(10) Pub. No.: US 2005/0098589 A1
(43) Pub. Date: May 12, 2005

(54) Valve device for opening a container comprising a re-aeration mechanism

(75) Inventors: Bernhard Felten, Pinneberg (DE); Holger Pries, Leer (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Beiersdorf AG

(21) Appl. No.: 10/947,062

(22) Filed: Sep. 21, 2004

Related U.S. Application Data
(63) Continuation of application No. PCT/EP02/03152, filed on Mar. 21, 2002.

(51) Int. Cl. B67D 3/00

(52) U.S. Cl. 222/481.5

(57) ABSTRACT

Valve device for arrangement in the area of a container opening and for metered discharge of a medium from the container, comprising a first valve that seals the container opening as long as a pressure difference between the interior of the container and the exterior of the container is smaller than a first predetermined limit value and that opens the container opening for the medium when the pressure difference between the interior of the container and the exterior of the container is greater than the first predetermined limit value, and a second valve that opens the container opening for admission of air as long as a pressure difference between the interior of the container and the exterior of the container is smaller than a second predetermined limit value and that seals the container opening for admission of air when the pressure difference between the interior of the container and the exterior of the container is greater than the second predetermined limit value. In the valve device, one of the first valve and the second valve is integrated in the other of the first valve and the second valve. The present invention also includes a container comprising the valve device.

### CROSS-REFERENCE TO RELATED APPLICATIONS

This is a continuation application of PCT/EP02/03152, filed Mar. 21, 2002, which is incorporated herein by reference in its entirety.

### FIELD OF THE INVENTION

The invention relates to a valve device for arrangement in the area of an opening of a container and for metered discharge of a medium from the container.

### BACKGROUND OF THE INVENTION

Many liquid and cream-like cosmetic products, but also food products, medical, domestic, chemical and technical products, are supplied in flexible bottles made of plastic (or in similar containers such as plastic tubes, canisters or the like). These are usually provided with a closure, preferably made of plastic. For product removal, the container is inclined, and, specifically in the case of somewhat more viscous products, the container is compressed in order for the product to be discharged. One example is shampoo, which, by virtue of the container being subjected to pressure, is forced out of a relatively small opening, and the container is provided with a so-called hinged lid. When sufficient shampoo has been discharged, the pressure is reduced and the container goes back to its original shape. The action of air being sucked in compensates for the absent volume which has been discharged. It is also the case here that residues of the product which are located in the region of the removal opening are also drawn back into the bottle. In the example of shampoo, these product residues are usually contaminated with spray water, as a result of its being used at a wash basin or in the shower. It is also possible, however, for the residues of shampoo around the pouring opening to be wiped off by hand, and then for sweat, skin residues and other substances on the skin to be sucked in as well.

In the medical sector, there are nasal sprays which are sold in flexible bottles. In the case of this application, it is possible for virus-containing nasal secretions to make their way into the bottle. When using body-care lotions or a suntan milk or oil, it is likewise possible, in addition to air, for other substances (sand, sea water, washing substances) to be sucked back into the container once the product has been applied to the skin.

One particular application is the use of massage heads for applying a shower product and massaging the skin. There is a greater possibility here of substances becoming detached from the skin during massage and being sucked into the opening of the massage head. In the food sector, there is the problem of contamination of container contents, for example, when mayonnaise is added to salads or sandwiches or when mustard is added to sausages. The substances which are sucked back may often contain bacteria, viruses or fungi. It is thus possible, in particular, for bacteria and fungi to multiply in the contents and thus render the latter unappetizing, inedible or, in extreme cases, even toxic.

The solution to the above problem which has been realized most frequently for products up until now, usually also because it is most cost-effective, is the use of preserving and stabilizing substances (benzoic acid, formaldehyde formers, nitrates, nitrites, antioxidants, ascorbic acid, etc).

Further attempts are being made to develop technical or structural means of avoiding the contamination of container contents. For example, the use of closures with relatively small openings and favorable geometry in combination with these substances usually ensures that the problem is kept within reasonable limits. A favorable geometry means that the closure is configured such that contact with the skin or other contaminated surfaces is made difficult.

It is likewise possible to design the container such that no air is drawn in, these designs being referred to as airless systems. Airless systems usually have a pump and a container with variable volume, for example a drawing plunger or inner bag (discharged by way of compressed air). These systems are also suitable for multi-chamber systems. The increased outlay usually gives rise to very much higher costs than a flexible plastic bottle. Moreover, removal of residues from these systems is usually very poor.

Systems with pumps deliver the substance from the bottle by way of a vertical tube. Volume compensation takes place by way of air which passes into the bottle via a separate channel. The channel is usually provided such that it is only open when the pump is actuated. This means that this channel is closed (usually by the pump plunger itself) in the rest state of the pump, and this provides a further safeguard against contamination by foreign substances. Pumping systems are slightly more advantageous than airless systems, but are still more expensive than straightforward bottles with a closure. The outlay for filling purposes is also higher.

A further development for dispensing systems for containers concerns the installation of valve systems for dispensing free-flowing or similar substances in a controlled manner. In the case of the diaphragm-valve containers which are available on the market, the opening of the vessel is closed by an elastic valve. Applying pressure to the bottle increases the pressure in the container, and the valve opens. When the pressure decreases, the valve closes again automatically. However, readmission of air is necessary here too, this also taking place via said valve in the case of a corresponding negative pressure in the bottle, and product residues and any contamination are also sucked back with such a valve structure. This system ensures that, when not in use, the container is closed and product does not pass out, nor do foreign substances pass in. Moreover, these valves are usually configured such that the stream of substance discharged ceases when the discharge pressure drops below a corresponding value, because the valve then abruptly snaps back and closes the opening. This ensures that the dispensing opening is only contaminated to a small extent, and the sucking-back action thus also takes place to a lesser degree.

WO 00/06460 describes a valve device which is intended for a container and is fitted in the area of the opening for metered discharge of a medium. WO 00/07899 and WO 00/07900 disclose valve systems which operate with diaphragms. WO 00/48921 discloses a valve with a two-way function, in which the discharge of a liquid and the ingress of air are ensured by both routes being opened simultaneously.

### SUMMARY OF THE INVENTION

The object of the invention is to provide a valve device for a container which ensures that the container contents are dispensed, allows readmission of air, and ensures that the product, once dispensed, does not flow back into the container. These measures are intended to avoid the disadvantages of the prior art.

Surprisingly, it has now been found that an excellent way of achieving this object is for two valves, which permit passage in different directions, to be integrated one inside the other.

Accordingly, the invention comprises a valve device for arrangement in the area of an opening of a container and for metered discharge of a medium from the container, with a first valve (discharge valve) which seals the container opening for the medium as long as a pressure difference between the interior of the container and the exterior of the container is smaller than a first predetermined limit value and which opens the container opening for the medium when the pressure difference between the interior of the container and the exterior of the container is greater than the first predetermined limit value, and with a second valve (air admission valve) which opens the container opening for readmission of air as long as a pressure difference between the interior of the container and the exterior of the container is smaller than a second predetermined limit value and which seals the container opening for readmission of air when the pressure difference between the interior of the container and the exterior of the container is greater than the second predetermined limit value, wherein one of the valves is integrated in the other of the valves.

To avoid misunderstanding, the pressure difference between the interior of the container and the exterior of the container is defined as the internal pressure of the container minus the external pressure of the container in the correct mathematical values, that is to say ones provided with algebraic signs. Giving the mathematical values provided with algebraic signs likewise applies to the way in which the first and the second predetermined limit values are given. Here, a negative value is chosen in principle for the second predetermined limit value.

The first valve is thus advantageously closed as long as a pressure difference in the interior of the container, where appropriate in the form of a slight positive pressure in relation to the exterior of the container is smaller than a first predetermined limit value, and it is open When the positive pressure is greater than the first predetermined limit value. Correspondingly, the second valve is open in the case of a negative pressure in the interior of the container in relation to the exterior of the container, and it is advantageously closed when this negative pressure is not present. To obtain a negative pressure in the interior of the container, the second predetermined limit value is therefore lower than zero.

In a first advantageous embodiment of the valve device according to the invention, the second valve (air admission valve) is integrated in the first valve (discharge valve).

### BRIEF DESCRIPTION OF THE SEVERAL VIEWS OF THE DRAWING(S)

The invention will be explained in more detail below with reference to FIGS. 1 through 3, although the choice of the embodiments illustrated should not be regarded as restricting the invention unnecessarily. The explanations relate to the first embodiment and its refinements. In the drawing:

FIG. 1 shows a container for liquid substances, with a hinged closure lid, and with the valve device according to the invention;

FIG. 2 shows the discharge path of the product from the container in FIG. 1; and

FIG. 3 shows the path of the air during readmission of air into the container in FIG. 1.

### DETAILED DESCRIPTION OF THE INVENTION

In a refinement of the valve device according to the invention, the discharge valve is a plunger valve, and, independently of this, but preferably in combination therewith, it has proven expedient for the air admission valve to be a disk valve.

In a second advantageous embodiment of the valve device according to the invention, the first valve (discharge valve) is integrated in the second valve (air admission valve). In this case, the air admission valve is advantageously a plunger valve and the discharge valve is a disk valve. For the concept of the invention, it is also very advantageous if two separate paths are provided for the discharge of the medium and for the readmission of air.

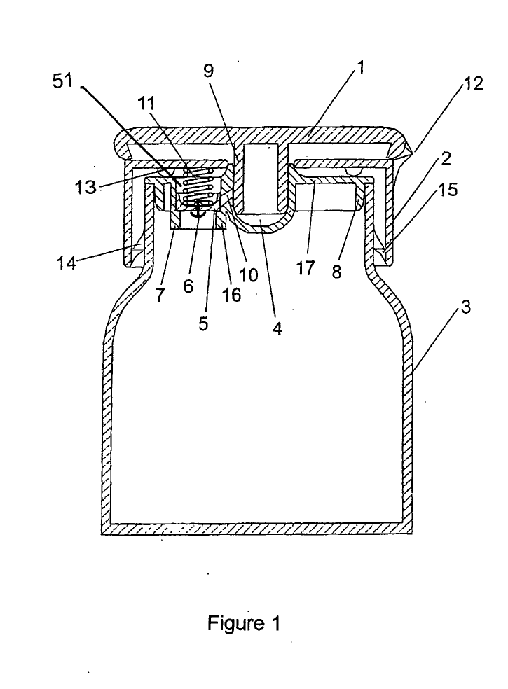

FIG. 1 shows a container, comprising a container body 3, a container insert 17 with the valve device according to the invention, and an attachment part 2, and with a container opening, which container opening can additionally be closed off by a lid 1. The valve device comprises a plunger valve with a plunger 5 which is designed to move up and down in the plunger channel formed by a cylinder 16, and of a disk valve 6 integrated in the plunger 5. A spring 11, in the illustrated embodiment a helical spring, has the effect that the plunger bears on a stop 7 when no external pressure is applied to the container body 3, that is to say when the pressure difference between the interior of the container and the exterior of the container is smaller than a first predetermined limit value. In this state, the plunger valve for the discharge of a medium from the interior of the plunger is closed, and the discharge opening 10 located in the cylinder 16 forming the wall of the plunger channel 51 is closed. This discharge opening 10 here constitutes a part of the container opening.

When the value drops below a second predetermined limit value between the interior of the container and the exterior of the container, which is identical to the first limit value, but preferably smaller, and in particular can be negative, the disk valve 6 is opened. This is the case in particular when the pressure in the interior of the container is lower than the pressure of the exterior of the container.

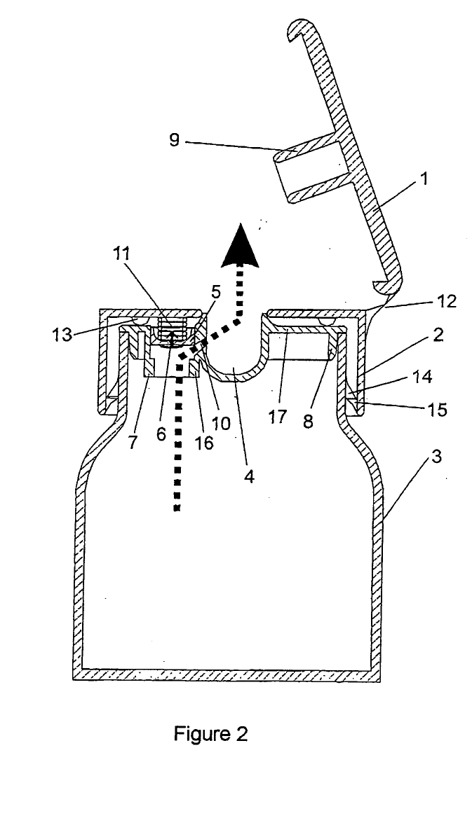

If the pressure of the interior of the container is increased, for example by squeezing the body 3 of the container, the plunger 5 in the cylinder 16 is moved against the spring 11 until the discharge opening 10 in the wall of the cylinder 16 is freed (compare also FIG. 2). The product can then pass through this discharge opening 10 into the outlet channel 4. Instead of a single discharge opening 10, several discharge openings can be provided in the wall of the cylinder 16 in order to increase the amount discharged.

The lid 1 is preferably designed as a hinged lid. It is secured movably on an attachment part 2 of the container body 3 via a hinge element 12. The outlet channel 4 can be opened by lifting the lid 1, so that a sealing plug 9 is withdrawn from the outlet channel 4.

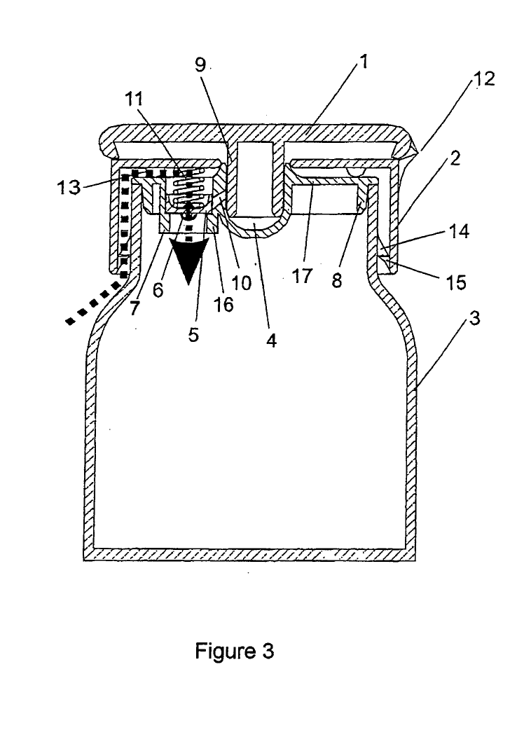

When the pressure difference between the interior of the container and the exterior of the container drops below the first limit value, the plunger 5 moves back, assisted by the restoring force of the spring 11, and once again closes the opening (compare FIG. 3).

When the pressure difference between the interior of the container and the exterior of the container drops further below the second limit value, particularly such that a negative pressure arises in the bottle, the plunger runs against the stop 7, and the disk valve 6 in the bottom of the plunger 5 comes into operation, allowing air to pass through into the bottle. The system is configured in such a way that normally no product can pass into an air admission channel 51 formed by the cylinder 16. The valves (plunger 5 and disk valve 6) forming the valve device each allow passage in only one direction, specifically only under the stated pressure conditions.

If structural measures are taken to optimize the air admission path with regard to contamination, such contamination can occur only with great difficulty. The path of the inflowing air on readmission runs, in this example, under the supports 13 and through the catch elements 14 and 15 for the attachment part 2, which allow air to pass through small gaps (not shown). The attachment part 2 in this example is secured on the container body 3 by a system of catch elements (locking hook 14 and snap-in hook 15). Here, the prior art affords other advantageous possibilities (threads, bands, crimps, etc.).

The container insert 17 containing the outlet channel 4 is held from the container body 3 by supports 13 and is sealed off from this by a sealing lip 8. For the formation of this seal, various designs are possible (barrel, cone, lamellas, cylinder). The insertion of a sealing ring or washer is advantageous.

FIG. 2 shows the discharge process via the valve device according to the invention in the event of an increase in the pressure in the interior of the container. The plunger 5 is displaced upward and compresses the spring 11. The disk valve is closed. The outlet path indicated by the bold arrow extends through the discharge opening 10.

In FIG. 3, the path of the inflowing air in the air readmission process is indicated by a bold arrow. The air passes through passages in the area of the catch elements 14 and 15, then through passages in the area of the supports 13, and flows through the opened disk valve 6 into the interior of the container.

The disk valve 6 can advantageously be designed in such a way that, after pressure compensation is achieved between the interior of the container and the exterior of the container, it closes again. Additional penetration of contaminating material is then avoided. This type of closure makes it possible, for example, to integrate an applicator and reliably ensures that substances cannot pass from the application surface back into the container.

In the case of the second embodiment and its refinements, a plunger valve connected in reverse (the opening 10 now serves as air admission opening) can be used as air admission valve, in which a disk valve (passage can be switched from inside outward) is integrated. However, other embodiments of the invention set out in the main claim can be realized too.

The valve device according to the invention is constructed in such a way that a return flow of discharged product from the applicator surface into the container is not possible. They are thus suitable for containers for free-flowing substances of all kinds, but additionally afford great advantages for containers which are designed for dispensing easily perishable substances and which have to satisfy strict hygiene demands.

A few examples of such application areas, without this being claimed as a complete list, are as follows:
Toothbrushes with integrated dispensing opening
Cleaning brushes with an integrated supply container
Grinding and polishing applicators in the corresponding container for auxiliary agents
Shower-gel applicators, in particular also with a massage head,
Mascara brushes,
Applicators for shoe creams or other cleaning and treating/preserving substances, in particular those with a brush or a sponge on the container for cleaning clothing,
Roll-on deodorants,
Applicators for nail polish or correction fluid,
Applicators for adhesives,
Applicators for paints, protective coatings, rust removers, caustic lyes etc.

The valve device is also highly suitable for the conventional container closures and applicators, including, for example, containers for substances for washing and body care (shampoo, shower gel, suntan milk, body-care lotion, etc.). As a result of contamination of the contents being more or less ruled out, the amount of preserving and stabilizing substances can be reduced to a considerable extent.

A further application for the valve device according to the invention is in the food sector, for example for jam, honey, ketchup and mayonnaise, mustard, sauces and the like.

By integrating the air readmission valve in the discharge valve system, it is possible to ensure a high degree of accuracy and precision in the injection-molding operation normally used for producing such articles. The quality of the product is improved. The valve device can also advantageously be made in one piece, by which means the number of production steps is reduced, the cost of production is lowered, and the accuracy of fit and the functionality are improved.

In a variation of the principle, the valve for air admission can be integrated in the container body instead of in the plunger. In addition, it is also possible for a plunger valve to be used for air admission, and for the outlet to be configured with a disk valve.

1. A valve device for arrangement in the area of an opening of a container having an interior and an exterior and for metered discharge of a medium from the container, comprising
a first valve that seals the container opening as long as a pressure difference between the interior of the container and the exterior of the container is smaller than a first predetermined limit value and that opens the container opening when the pressure difference between the interior of the container and the exterior of the container is greater than the first predetermined limit value; and
a second valve that opens the container opening for the admission of air as long as a pressure difference between the interior of the container and the exterior of the container is smaller than a second predetermined limit value and that seals the container opening for the admission of air when the pressure difference between the interior of the container and the exterior of the container is greater than the second predetermined limit value;
wherein one of the first valve and the second valve is integrated in the other of the first valve and the second valve.

2. The valve device as claimed in claim 1, wherein the second valve is integrated in the first valve.

3. The valve device as claimed in claim 2, wherein the first valve is a plunger valve.

4. The valve device as claimed in claim 3, wherein the second valve is a disk valve.

5. The valve device as claimed in claim 2, wherein the second valve is a disk valve.

6. The valve device as claimed in claim 1, wherein the first valve is a plunger valve.

7. The valve device as claimed in claim 6, wherein the second valve is a disk valve.

8. The valve device as claimed in claim 1, wherein the second valve is a disk valve.

9. The valve device as claimed in claim 1, wherein the first valve is integrated in the second valve.

10. The valve device as claimed in claim 9, wherein the second valve comprises a plunger valve.

11. The valve device as claimed in claim 10, wherein the first valve comprises a disk valve.

12. The valve device as claimed in claim 9, wherein the first valve comprises a disk valve.

13. The valve device as claimed in claim 1, wherein the second valve comprises a plunger valve.

14. The valve device as claimed in claim 1, wherein the first valve comprises a disk valve.

15. The valve device as claimed in claim 1, wherein two separate paths are provided for discharge of the medium and for admission of air.

16. A container insert adapted for dispensing a medium from an interior of a container, said container insert comprising:
a discharge valve movable from a closed position to an open position in response to a pressure in the interior of the container above a first predetermined limit, and from an open position to a closed position in response to a pressure in the interior of the container below the first predetermined limit;
an air admission valve movable from a closed position to an open position in response to a pressure in the interior of the container below a second predetermined level, and from an open position to a closed position in response to a pressure in the interior of the container equal to or greater than the second predetermined level;
at least one discharge opening for dispensing the medium from the interior of the container in response to a pressure in the interior of the container above the first predetermined limit; and
at least one air admission channel for supplying air into the interior of the container in response to a pressure in the interior of the container below the second predetermined level,
wherein the at least one air admission channel and the at least one discharge opening each define a separate pathway for the admission of air and the discharge of the medium, respectively;
wherein the discharge valve is movably disposed in a discharge channel having a wall; and
wherein said at least one discharge opening is disposed in said wall, whereby medium passes from said interior through said at least one discharge opening and into said discharge channel in response to a pressure in the interior of the container above the first predetermined limit.

17. The container insert as claimed in claim 16, wherein said discharge valve comprises a plunger and said air admission valve comprises a disk valve integrally disposed in said plunger.

18. The container insert as claimed in claim 16, further comprising an outlet channel connected to said discharge channel, whereby the medium passes from said discharge channel into said outlet channel.

19. The container insert as claimed in claim 16, further comprising a lid for sealably closing said insert.

20. A container, comprising:
an interior;
an exterior;
an opening; and
a valve device arranged in the opening for metered discharge of a medium from the container, comprising
a first valve that closes the opening as long as a pressure difference between the interior and the exterior is smaller than a first predetermined limit value and that opens the opening when the pressure difference between the interior and the exterior is greater than the first predetermined limit value; and
a second valve that opens the opening for the admission of air as long as a pressure difference between the interior and the exterior is smaller than a second predetermined limit value and that closes the opening for the admission of air when the pressure difference between the interior and the exterior is greater than the second predetermined limit value;
wherein one of the first valve and the second valve is integrated in the other of the first valve and the second valve.

21. The container as claimed in claim 20, wherein the second valve is integrated in the first valve.

22. The container as claimed in claim 21, wherein the first valve is a plunger valve.

23. The container as claimed in claim 21, wherein the second valve is a disk valve.

24. The container as claimed in claim 20, wherein the first valve is integrated in the second valve.

25. The container as claimed in claim 24, wherein the second valve comprises a plunger valve.

26. The container as claimed in claim 24, wherein the first valve comprises a disk valve.

27. The container as claimed in claim 20, wherein two separate paths are provided for discharge of the medium and for admission of air.

28. A container for dispensing a medium, comprising:
an interior;
at least one discharge opening in communication with the interior of the container;
a discharge valve movable from a closed position to an open position in response to a pressure in the interior of the container above a first predetermined limit to dispense the medium from the interior of the container through the at least one discharge opening, and from an open position to a closed position in response to a pressure in the interior of the container below the first predetermined limit;
at least one air admission channel in communication with the interior of the container, and
an air admission valve movable from a closed position to an open position in response to a pressure in the interior of the container below a second predetermined level to admit air into the interior of the container through the at least one air admission channel, and from an open position to a closed position in response to a pressure in the interior of the container equal to or greater than the second predetermined level;
wherein the at least one air admission channel and the at least one discharge opening each define a separate pathway for the admission of air and the discharge of the medium, respectively.

29. The container as claimed in claim 28, wherein the air admission valve is integrally disposed in the discharge valve.

30. The container as claimed in claim 28, wherein said discharge valve comprises a plunger and the air admission valve comprises a disk valve.
